(19) United States
(12) Patent Application Publication
(10) Pub. No.: US 2008/0086550 A1
(43) Pub. Date: Apr. 10, 2008

(54) INTEGRATION OF DATA BETWEEN DEVICES

(75) Inventors: Robert Z. Evora, Douglasville, GA (US); Coulter C. Henry, Marietta, GA (US); Jeffrey C. Mikan, Cumming, GA (US)

Correspondence Address: WOODCOCK WASHBURN LLP, CIRA CENTRE 12th Floor, 2929 ARCH STREET, PHILADELPHIA, PA, 19104-2891, US

(73) Assignee: Cingular Wireless II, LLC, Atlanta, GA (US)

(21) Appl. No.: 11/539,257

(22) Filed: Oct. 6, 2006

(51) Int. Cl. G06F 15/173

(52) U.S. Cl. 709/223

(57) ABSTRACT

Methods, systems and computer-readable media are provided that enable multimedia content to be switched from a first to a second device. In one such method, multimedia content is streamed to a first device and a request to transfer the multimedia content from the first device to a second device is detected. A determination is made as to whether the multimedia content is to be (i) streamed to the second device or (ii) streamed to the second device by way of the first device. The multimedia content is then streamed to the second device in accordance with the determination.

### BACKGROUND

Multimedia content, such as music, television, films and the like, conventionally have been delivered to consumers in a relatively fixed manner. For example, a consumer can receive a television program in the consumer's home by way of a wired connection. If, after beginning to watch the program, the consumer wishes to watch the program in a different location, the consumer's choices are limited to locations in which a television has already been placed and connected. Alternatively, the consumer can disconnect the television and move it to another location. If the consumer's television is receiving the program by way of a wired (e.g., cable) connection, the consumer must ensure that the television is within reach of a cable outlet.

A conventional method for enabling portability of multimedia content is to provide different channels for receiving the data stream representing the content. For example, the consumer may be able to access Internet Protocol (IP) based multimedia content by way of a personal computer. If the content is a television program, the consumer may access the content through his or her television by way of a cable or other connection. In addition, a consumer may now use various cellular technologies that provide increased bandwidth such that the transmission of multimedia content (e.g., multimedia messages, as well as music and video content) to mobile subscribers is now possible.

Unfortunately, a significant shortcoming exists because the communication method used for one device conventionally cannot be used by the other devices in a substantially real-time manner. Thus, separate—and therefore redundant—communication methods must be made available for each device. For example, a consumer may have to provide, and pay for, a separate communication channel for his or her television, personal computer (unless enabled with a TV decoder, which the consumer would have to purchase at additional expense) and cellular telephone. In such a scenario, the only way to switch between devices during the delivery of program content is to select the same program from each communication channel. Unless the program was being transmitted live, the consumer typically cannot resume the program where he or she stopped with the previous device because each communication channel does not use the same data stream to deliver the content. Instead, the consumer would have to select the program on the new device (which may involve paying for the program a second time) and then manually advance the program to the point at which the consumer stopped using the previous device.

In addition to the inconvenience a consumer experiences when trying to switch between devices while receiving multimedia content, the consumer is also forced to have a separate communication channel for every device. Such an arrangement is redundant, and can be expensive. Thus, it can be seen that a need exists for an automated mechanism to transfer and adjust a data stream that is being sent to a first device when switching to a second device.

### SUMMARY

In view of the above shortcomings and drawbacks, methods, systems and computer-readable media are provided that enable multimedia content to be switched from a first to a second device. In one such method, multimedia content is streamed to a first device and a request to transfer the multimedia content from the first device to a second device is detected. A determination is made as to whether the multimedia content is to be (i) streamed to the second device or (ii) streamed to the second device by way of the first device. The multimedia content is then streamed to the second device in accordance with the determination.

### BRIEF DESCRIPTION OF THE DRAWINGS

The foregoing Summary, as well as the following detailed description, is better understood when read in conjunction with the appended drawings. For the purpose of illustrating various embodiments, there is shown in the drawings example embodiments; however, such embodiments are not limited to the specific methods and instrumentalities disclosed. In the drawings:

FIG. 1A illustrates an overview of a network environment in which aspects of an embodiment may be implemented;

FIG. 1B illustrates a GPRS network architecture in which aspects of an embodiment may be implemented; and

FIG. 1C illustrates an alternate block diagram of an example GSM/GPRS/IP multimedia network architecture in which aspects of an embodiment may be implemented;

FIGS. 2-4 illustrate simplified network architectures in which aspects of an embodiment may be implemented; and

FIG. 5 is a flowchart illustrating an example method of transferring multimedia content between devices according to an embodiment.

### DETAILED DESCRIPTION

The subject matter of the various embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

### Example Network and Operating Environments

The below-described architecture for transferring multimedia content between devices may be applied to any type of network, however, the following description sets forth some example telephony radio networks and non-limiting operating environments. The below-described operating environments should be considered non-exhaustive, however, and thus the below-described network architecture merely shows an example network architecture in which aspects of various embodiments may be incorporated. One can appreciate, however, that aspects of an embodiment may be incorporated into now existing or future alternative architectures for communication networks.

The global system for mobile communication (“GSM”) is one of the most widely-used wireless access systems in today's fast growing communication systems. GSM provides circuit-switched data services to subscribers, such as mobile telephone or computer users, for example. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications. For purposes of explanation, various embodiments are described herein in connection with GSM. The references to GSM are not exclusive, however, as it should be appreciated that embodiments may be implemented in connection with any type of wireless access system such as, for example, CDMA or the like.

As may be appreciated, the example GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the various embodiments discussed below may be applied independently of the method of data transport, and does not depend on any particular network architecture, or underlying protocols.

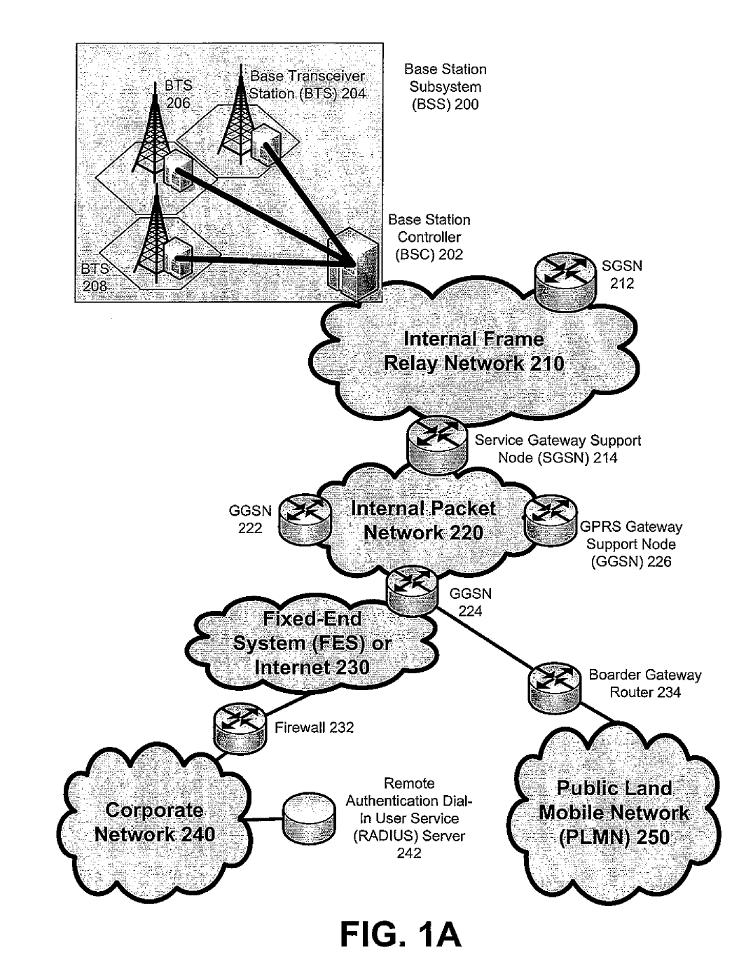

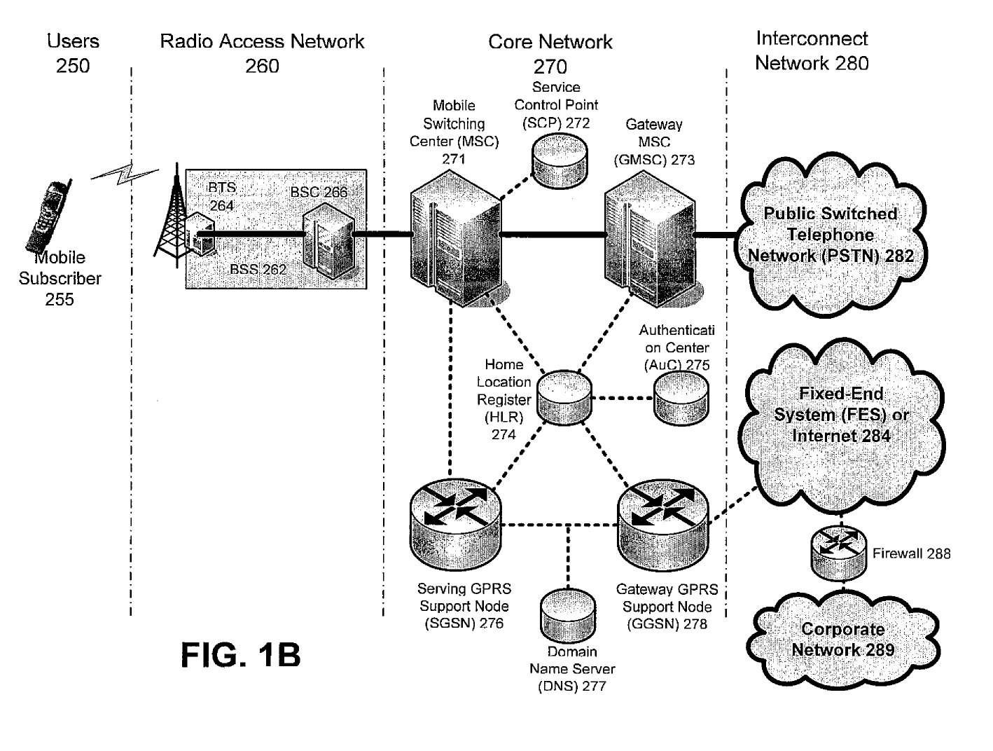

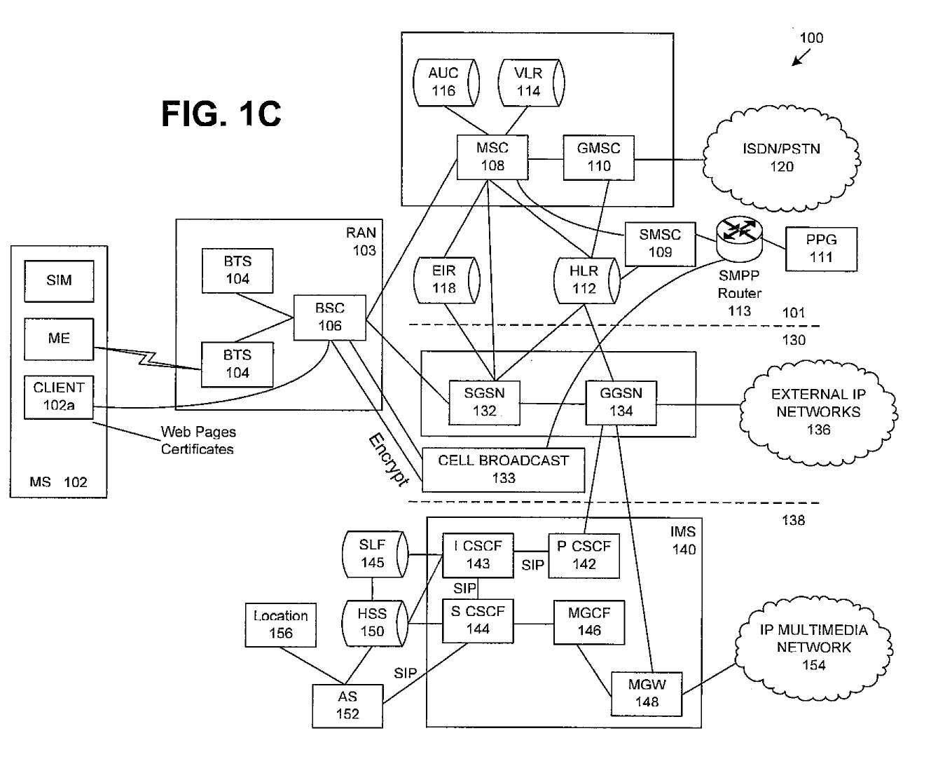

FIG. 1A depicts an overall block diagram of an example packet-based mobile cellular network environment, such as a GPRS network, in which aspects of an embodiment may be practiced. In such an environment, there may be any number of subsystems that implement the functionality of the environment such as, for example, a plurality of Base Station Subsystems (“BSS”) 200 (only one is shown in FIG. 1A), each of which comprises a Base Station Controller (“BSC”) 202 serving a plurality of Base Transceiver Stations (“BTS”) such as, for example, BTSs 204, 206 and 208. BTSs 204, 206, 208, etc., are the access points where users of packet-based mobile devices become connected to the wireless network. In one embodiment, the packet traffic originating from user devices is transported over the air interface to BTS 208, and from BTS 208 to BSC 202. Base station subsystems, such as BSS 200, may be a part of internal frame relay network 210 that may include Service GPRS Support Nodes (“SGSN”) such as SGSN 212 and 214. Each SGSN 212, 214, etc. is in turn connected to internal packet network 220 through which SGSN 212, 214, etc. can route data packets to and from a plurality of gateway GPRS support nodes (GGSN) 222, 224, 226, etc. As illustrated, SGSN 214 and GGSNs 222, 224 and 226 are part of internal packet network 220. Gateway GPRS serving nodes 222, 224 and 226 may provide an interface to external Internet Protocol (“IP”) networks such as Public Land Mobile Network (“PLMN”) 250, corporate intranets 240, Fixed-End System (“FES”), the public Internet 230 or the like. As illustrated, subscriber corporate network 240 may be connected to GGSN 224 via firewall 232; and PLMN 250 may be connected to GGSN 224 via boarder gateway router 234. Remote Authentication Dial-In User Service (“RADIUS”) server 242 may be used for caller authentication when a user of a mobile cellular device calls corporate network 240, for example.

Generally, there can be four different cell sizes in a GSM network—macro, micro, pico and umbrella cells. The coverage area of each cell is different in different environments. Macro cells may be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

FIG. 1B illustrates the architecture of a typical GPRS network as segmented into four groups: users 250, radio access network 260, core network 270 and interconnect network 280. Users 250 comprise a plurality of end users (though only mobile subscriber 255 is shown in FIG. 1B). Radio access network 260 comprises a plurality of base station subsystems such as BSSs 262, which include BTSs 264 and BSCs 266. Core network 270 comprises a host of various network elements. As illustrated here, core network 270 may comprise Mobile Switching Center (“MSC”) 271, Service Control Point (“SCP”) 272, gateway MSC 273, SGSN 276, Home Location Register (“HLR”) 274, Authentication Center (“AuC”) 275, Domain Name Server (“DNS”) 277 and GGSN 278. Interconnect network 280 also comprises a host of various networks and other network elements. As illustrated in FIG. 1B, interconnect network 280 comprises Public Switched Telephone Network (“PSTN”) 282, Fixed-End System (“FES”) or Internet 284, firewall 288 and Corporate Network 289.

A mobile switching center may be connected to a large number of base station controllers. At MSC 271, for example, depending on the type of traffic, the traffic may be separated such that voice may be sent to Public Switched Telephone Network (“PSTN”) 282 through Gateway MSC (“GMSC”) 273, and/or data may be sent to SGSN 276, which then sends the data traffic to GGSN 278 for further forwarding.

When MSC 271 receives call traffic, for example, from BSC 266, it may send a query to a database hosted by SCP 272. The SCP 272 processes the request and issues a response to MSC 271 so that it may continue call processing as appropriate.

HLR 274 is a centralized database for users to register to the GPRS network. HLR 274 stores static information about the subscribers such as the International Mobile Subscriber Identity (“IMSI”), subscribed services, and a key for authenticating the subscriber. HLR 274 also stores dynamic subscriber information such as the current location of the mobile subscriber. Associated with HLR 274 may be AuC 275. AuC 275 is a database that contains the algorithms for authenticating subscribers and includes the associated keys for encryption to safeguard the user input for authentication.

In the following, depending on context, the term “mobile subscriber” may refer to either the end user or to the actual portable device used by an end user of the mobile cellular service. When a mobile subscriber turns on his or her mobile device, the mobile device goes through an attach process by which the mobile device attaches to an SGSN of the GPRS network. Referring now to FIG. 1B, when mobile subscriber 255 initiates the attach process by turning on the network capabilities of the mobile device, an attach request is sent by mobile subscriber 255 to SGSN 276. The SGSN 276 queries another SGSN, to which mobile subscriber 255 was attached before, for the identity of mobile subscriber 255. Upon receiving the identity of mobile subscriber 255 from the other SGSN, SGSN 276 requests more information from mobile subscriber 255. This information is used to authenticate mobile subscriber 255 to SGSN 276 by HLR 274. Once verified, SGSN 276 sends a location update to HLR 274 indicating the change of location to a new SGSN, in this case SGSN 276. HLR 274 notifies the old SGSN, to which mobile subscriber 255 was attached, to cancel the location process for mobile subscriber 255. HLR 274 then notifies SGSN 276 that the location update has been performed. At this time, SGSN 276 sends an Attach Accept message to mobile subscriber 255, which in turn sends an Attach Complete message to SGSN 276.

After attaching itself with the network, mobile subscriber 255 then goes through the authentication process. In the authentication process, SGSN 276 sends the authentication information to HLR 274, which sends information back to SGSN 276 based on the user profile that was part of the user's initial setup. SGSN 276 then sends a request for authentication and ciphering to mobile subscriber 255. Mobile subscriber 255 uses an algorithm to send the user identification (ID) and password to SGSN 276. SGSN 276 uses the same algorithm and compares the result. If a match occurs, SGSN 276 authenticates mobile subscriber 255.

Next, mobile subscriber 255 establishes a user session with the destination network, corporate network 289, by going through a Packet Data Protocol (“PDP”) activation process. Briefly, in the process, mobile subscriber 255 requests access to the Access Point Name (“APN”), for example, UPS.com (e.g., which can be corporate network 279) and SGSN 276 receives the activation request from mobile subscriber 255. SGSN 276 then initiates a Domain Name Service (“DNS”) query to learn which GGSN node has access to the UPS.com APN. The DNS query is sent to the DNS server within the core network 270, such as DNS 277, which is provisioned to map to one or more GGSN nodes in the core network 270. Based on the APN, the mapped GGSN 278 can access the requested corporate network 279. The SGSN 276 then sends to GGSN 278 a Create Packet Data Protocol (“PDP”) Context Request message that contains necessary information. The GGSN 278 sends a Create PDP Context Response message to SGSN 276, which then sends an Activate PDP Context Accept message to mobile subscriber 255.

Once activated, data packets of the call made by mobile subscriber 255 can then go through radio access network 260, core network 270, and interconnect network 280, in particular fixed-end system or Internet 284 and firewall 288, to reach corporate network 289.

Thus, network elements that may implicate the functionality of the service delivery based on real-time performance requirement(s) in accordance with an embodiment may include but are not limited to Gateway GPRS Support Node tables, Fixed End System router tables, firewall systems, VPN tunnels and any number of other network elements as required by the particular digital network.

FIG. 1C shows another example block diagram view of a GSM/GPRS/IP multimedia network architecture 100 in which the apparatus and methods for transferring multimedia content between receiving devices of the below-discussed embodiments may be incorporated. As illustrated, architecture 100 of FIG. 1C includes GSM core network 101, GPRS network 130 and IP multimedia network 138. GSM core network 101 includes Mobile Station (MS) 102, at least one Base Transceiver Station (BTS) 104 and Base Station Controller (BSC) 106. MS 102 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. BTS 104 is physical equipment, such as a radio tower, that enables a radio interface to communicate with the MS. Each BTS may serve more than one MS. BSC 106 manages radio resources, including the BTS. The BSC may be connected to several BTSs. The BSC and BTS components, in combination, are generally referred to as a base station (BSS) or radio access network (RAN) 103.

GSM core network 101 also includes Mobile Switching Center (MSC) 108, Gateway Mobile Switching Center (GMSC) 110, Home Location Register (HLR) 112, Visitor Location Register (VLR) 114, Authentication Center (AuC) 118 and Equipment Identity Register (EIR) 116. MSC 108 performs a switching function for the network. The MSC also performs other functions, such as registration, authentication, location updating, handovers and call routing. GMSC 110 provides a gateway between the GSM network and other networks, such as an Integrated Services Digital Network (ISDN) or Public Switched Telephone Networks (PSTNs) 120. In other words, GMSC 110 provides interworking functionality with external networks.

HLR 112 is a database that contains administrative information regarding each subscriber registered in a corresponding GSM network. HLR 112 also contains the current location of each MS. VLR 114 is a database that contains selected administrative information from HLR 112. The VLR contains information necessary for call control and provision of subscribed services for each MS currently located in a geographical area controlled by the VLR. HLR 112 and VLR 114, together with MSC 108, provide the call routing and roaming capabilities of GSM. AuC 116 provides the parameters needed for authentication and encryption functions. Such parameters allow verification of a subscriber's identity. EIR 118 stores security-sensitive information about the mobile equipment.

Short Message Service Center (SMSC) 109 allows one-to-one Short Message Service (SMS) messages to be sent to/from MS 102. Push Proxy Gateway (PPG) 111 is used to “push” (i.e., send without a synchronous request) content to MS 102. PPG 111 acts as a proxy between wired and wireless networks to facilitate pushing of data to MS 102. Short Message Peer to Peer (SMPP) protocol router 113 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. MS 102 sends a location update including its current location information to the MSCNVLR, via BTS 104 and BSC 106. The location information is then sent to the MS's HLR. The HLR is updated with the location information received from the MSCNVLR. The location update also is performed when the MS moves to a new location area. Typically, the location update is periodically performed to update the database as location updating events occur.

GPRS network 130 is logically implemented on the GSM core network architecture by introducing two packet-switching network nodes, a serving GPRS support node (SGSN) 132, a cell broadcast and a Gateway GPRS support node (GGSN) 134. SGSN 132 is at the same hierarchical level as MSC 108 in the GSM network. The SGSN controls the connection between the GPRS network and MS 102. The SGSN also keeps track of individual MS's locations and security functions and access controls.

Cell Broadcast Center (CBC) 133 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

GGSN 134 provides a gateway between the GPRS network and a public packet network (PDN) or other IP networks 136. That is, the GGSN provides interworking functionality with external networks, and sets up a logical link to the MS through the SGSN. When packet-switched data leaves the GPRS network, it is transferred to external TCP-IP network 136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

GPRS network 130 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

IP multimedia network 138 was introduced with 3GPP Release 5, and includes IP multimedia subsystem (IMS) 140 to provide rich multimedia services to end users. A representative set of the network entities within IMS 140 are a call/session control function (CSCF), media gateway control function (MGCF) 146, media gateway (MGW) 148, and a master subscriber database, referred to as a home subscriber server (HSS) 150. HSS 150 may be common to GSM network 101, GPRS network 130 as well as IP multimedia network 138.

IP multimedia system 140 is built around the call/session control function, of which there are three types: interrogating CSCF (I-CSCF) 143, proxy CSCF (P-CSCF) 142 and serving CSCF (S-CSCF) 144. P-CSCF 142 is the MS's first point of contact with IMS 140. P-CSCF 142 forwards session initiation protocol (SIP) messages received from the MS to an SIP server in a home network (and vice versa) of the MS. P-CSCF 142 may also modify an outgoing request according to a set of rules defined by the network operator (for example, address analysis and potential modification).

I-CSCF 143 forms an entrance to a home network and hides the inner topology of the home network from other networks and provides flexibility for selecting an S-CSCF. I-CSCF 143 may contact subscriber location function (SLF) 145 to determine which HSS 150 to use for the particular subscriber, if multiple HSSs 150 are present. S-CSCF 144 performs the session control services for MS 102. This includes routing originating sessions to external networks and routing terminating sessions to visited networks. S-CSCF 144 also decides whether application server (AS) 152 is required to receive information on an incoming SIP session request to ensure appropriate service handling. This decision is based on information received from HSS 150 (or other sources, such as application server 152). AS 152 also communicates to location server 156 (e.g., a Gateway Mobile Location Center (GMLC)) that provides a position (e.g., latitude/longitude coordinates) of MS 102.

HSS 150 contains a subscriber profile and keeps track of which core network node is currently handling the subscriber. It also supports subscriber authentication and authorization functions (AAA). In networks with more than one HSS 150, a subscriber location function provides information on HSS 150 that contains the profile of a given subscriber.

The MGCF 146 provides interworking functionality between SIP session control signaling from IMS 140 and ISUP/BICC call control signaling from the external GSTN networks (not shown). It also controls media gateway (MGW) 148 that provides user-plane interworking functionality (e.g., converting between AMR- and PCM-coded voice). MGW 148 also communicates with other IP multimedia networks 154.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, may not indicate the actual physical location of the mobile phones outside the pre-defined area.

Example Configurations

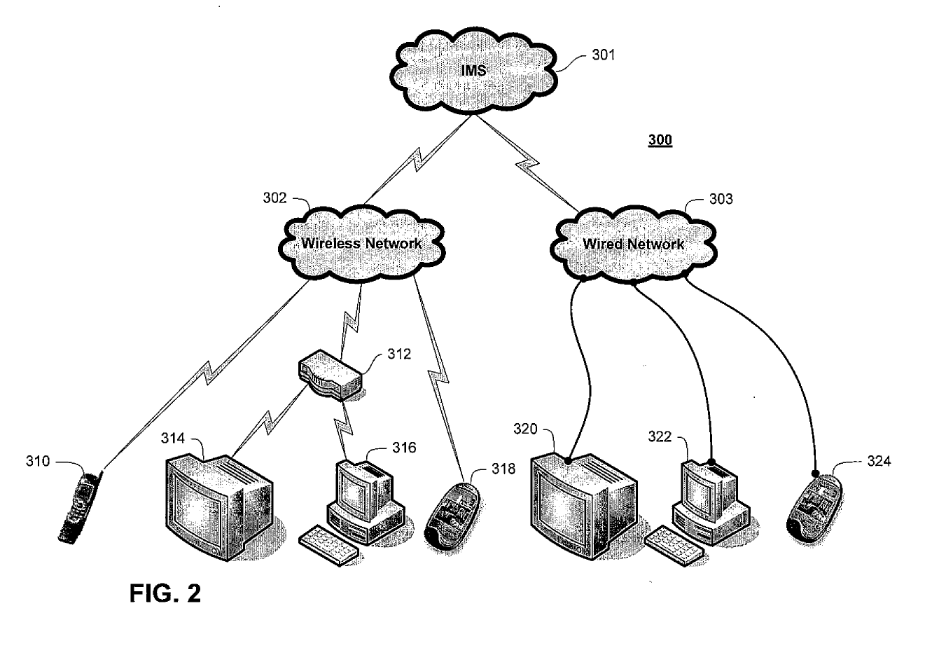

Now that example networks and operating environments in which aspects of various embodiments may be employed have been discussed, simplified network architectures in which aspects of an embodiment may be implemented are illustrated in connection with FIGS. 2-4. Referring now to FIG. 2, Internet Protocol (IP) Multimedia Subsystem (IMS) 301 represents any type of Next Generation Networking (NGN) architecture—or other architecture—that may provide mobile and/or fixed multimedia content services such as IP-based television, broadcast television, music, etc. In an embodiment, IMS 301 may provide multimedia content over a cellular connection, fixed connection such as cable or POTS telephone service, or the like. Operatively connected to IMS 301 may be wireless network 302 and wired network 303.

Wireless network 302 may be any type of network that enables wireless communication, such as, for example, a network provided by the architectures discussed above in connection with FIGS. 1A-C, a CDMA cellular network, a satellite network or the like. Wired network 303 may be any type of network such as, for example, a cable network, optical fiber network, POTS-based network, etc. Mobile subscriber 310 may be any type of wireless communication device. For example, in one embodiment mobile subscriber 310 may be mobile subscriber 255 as discussed above in connection with FIG. 1A, mobile subscriber 102 as discussed above in connection with FIG. 1C, or the like.

Router/modem 312 may be any type of device that is capable of operatively interconnecting television 314 and/or personal computer 316 with wireless network 302. For example, in one embodiment router/modem 312 may be a card adapted into a Type II laptop slot, or the like. Router/modem 312 may be external or internal to one or both of television 314 or personal computer 316. Televisions 314 and 320 may be any type of television (e.g., CRT, LCD, plasma, etc.), and may be conventional. Personal computers 316 and 322 may be any type of computing device, such as a desktop computer, laptop computer or the like. Personal Digital Assistant (PDA) 318 may be any type of portable computing device. Although not shown in FIG. 2, television 320 and/or personal computer 322 may have an internal or external router or modem, such as router/modem 312, to enable television 320 and/or personal computer 322 to have operative communication with wired network 303.

The configuration depicted in FIG. 2 illustrates different pathways by which various devices 310, 314, 316, 318, 320, 322 and 324 may be able to receive multimedia content from, for example, IMS 301. For example, mobile subscriber 310 or PDA 318 may be able to directly connect to wireless network 302 by way of a cellular network. Such cellular access may be via a GSM access system discussed above in connection with FIGS. 1A-C, a CDMA system, or any type of cellular system now in existence or to be developed in the future. Television 314 and personal computer 316 may be operatively connected to wireless network 302 by way of router/modem 312 that, as noted above, may be internal or external to either of television 314 and/or personal computer 316. Although not illustrated in the configuration of FIG. 2, either of mobile subscriber 310 or PDA 318 may be operatively connected to wireless network 302 by way of router/modem 312. Wireless network 302 may be in operative communications with IMS 301 through any conventional or future-developed mechanism.

Television 320, personal computer 322 and PDA 324 are operatively connected to wired network 303. It will be appreciated that television 320, personal computer 322 and PDA 324 may be television 314, personal computer 316 and PDA 318, respectively, when using an alternative communication channel. Wired network 303 may be any type of non-wireless network such as, for example, a cable network, DSL network or any other current or future-developed wired network. Thus, each of television 320, personal computer 322 and PDA 324 may be operatively connected to wired network 303 in a manner that is appropriate for the type of wired network 303. Wired network 303 may be, in turn, operatively connected to IMS 301.

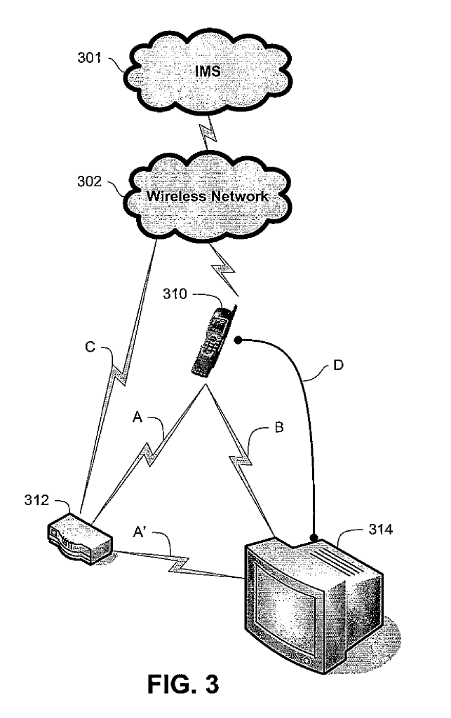

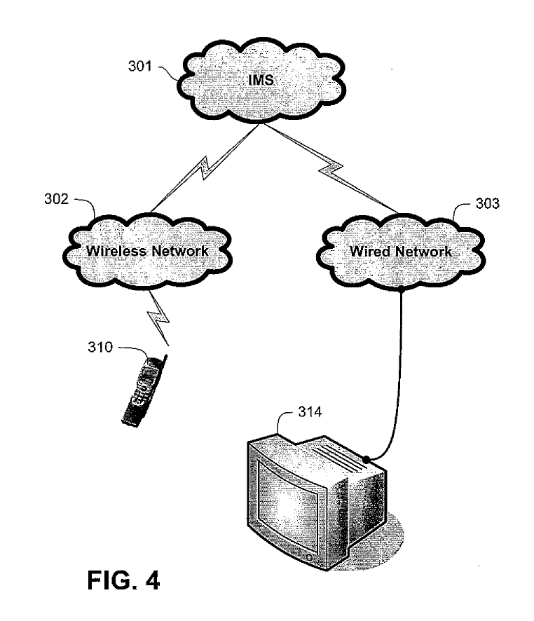

As will be discussed below in connection with FIGS. 3 and 4, an embodiment may enable a transition between any type of communication connection. For example, a user who is accessing multimedia content on mobile subscriber 310 via wireless network 302 may cause the content to be redirected to any of devices 314-324 by way of either wireless network 302 or wired network 303. It will be appreciated, therefore, that a user who is accessing multimedia content on any of devices 310 and 314-324 may transfer such content to any other of such devices 310 and 314-324. It will also be appreciated that the request to transfer the multimedia content could be initiated from the device to which the multimedia content is to be transferred. For example, if a consumer desires to transfer multimedia content from mobile subscriber 310 to television 314, the transfer of the multimedia content may be initiated by television 314.

Referring now to FIG.3, it can be seen that a portion of the configuration of FIG. 2 is illustrated for purposes of explaining one embodiment in which mobile subscriber 310 provides multimedia content to television 314. Upon detecting a request to transfer content to television 314, wireless network 302 may reformat the content for a characteristic of television 314. Such reformatting may include, for example, a change to the resolution (e.g., from a cellular phone display to a high-definition display), data rate, screen size, audio format, etc.

As noted above, the request to transfer the multimedia content from mobile subscriber 310 to television 314 may be sent to wireless network 302 by either mobile subscriber 310 or television 314. For example, mobile subscriber 310 may be placed into a docking station or the like, which may indicate to wireless network 302 that a transfer of content to television 314 should take place. A user of mobile subscriber 310 may manually indicate that a transfer is to take place using a menu or other input mechanism on mobile subscriber 310 itself. Alternatively, television 314 may automatically request a transfer of content from mobile subscriber upon some predetermined or user-initiated event. For example, a user of television 314 may select, by way of a menu or other input mechanism, to receive multimedia content that is being provided to mobile subscriber 310.

In the embodiment illustrated in FIG. 3, both the transmission of multimedia content to mobile subscriber 310 and television 314 may take place by way of wireless network. Once wireless network 302 has performed any reformatting of the multimedia content in preparation for transmission (if any such reformatting was performed at all), the multimedia content is transferred to television 314. Connections A, A′, B, C and D represent different example pathways such multimedia content may take to reach television 314. Connections C and A′0 indicate a wireless path that occurs directly from wireless network 302 to router/modem 312 (connection C), and then to television 314 (connection A′). Connection C may be, for example, a cellular connection while connection A′ may be, for example, a cellular connection or other wireless connection, such as WiFi, Bluetooth, etc. Connections A and A′ indicate a wireless path from mobile subscriber 310—which itself has received the multimedia content from wireless network 302—to router/modem 312 and then to television 314.

Mobile subscriber 310, after receiving multimedia content from wireless network 302, may transfer the content in a wired or wireless fashion directly to television 314. For example, connection B indicates a wireless path from mobile subscriber 310 directly to television 314. Such a connection may be, for example, a WiFi, Bluetooth or other connection. Connection D indicates a wired path from mobile subscriber 310 to television 314. The wired path of connection D may be, for example, a USB cable or the like.

Once the transfer of multimedia content to television 314 is complete (e.g., the content begins to be streamed to television 314 in place of or in addition to mobile subscriber 310), the multimedia content may continue at the point the user initiated the transfer (or when the transfer was initiated by automated means). Alternatively, the multimedia content may be resumed at a point that is either before or after the time at which the transfer was initiated. For example, the content may be resumed at a predetermined amount of time before the transfer was initiated to ensure that the user does not miss any content that may have otherwise have been lost during the transfer process. In an embodiment, the transfer process may be very quick (e.g., one second or less) and therefore any such content loss may be minor.

As can be seen in FIG. 3, all multimedia content is delivered by way of wireless network 302. However, an embodiment contemplates any combination of wired and/or wireless multimedia content delivery. Therefore, and referring now to FIG. 4, an example configuration involving both wireless network 302 and wired network 303 is illustrated. In the example configuration of FIG. 4, mobile subscriber 310 may be operatively connected to wireless network 302, as discussed above. Television 314 may be operatively connected to wired network 303. Thus, multimedia content may be transferred from a device that is connected to wireless network 302 to wired network 303, or vice-versa. For example, mobile subscriber 310 (or a user thereof) may initiate the transfer of multimedia content to television 314. Alternatively, television 314 (or a user thereof) may initiate the transfer. It will be appreciated that additional equipment may serve to operatively connect television 314 to wired network 303 such as, for example, a cable box, router, modem, etc.

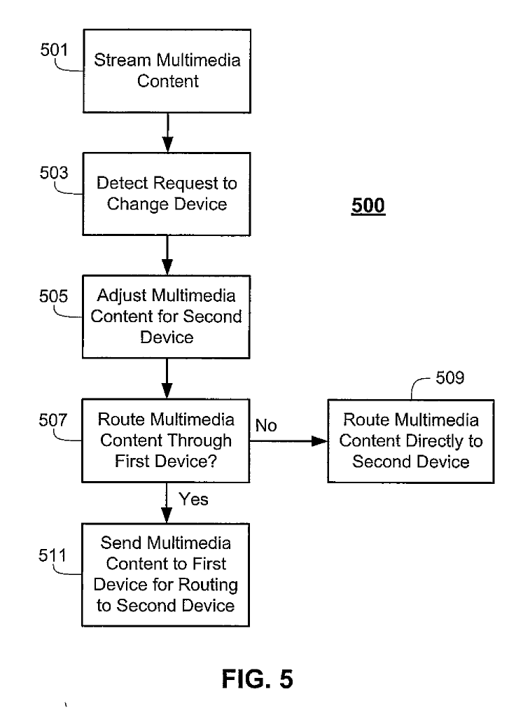

FIG. 5 is a flowchart illustrating an example method 500 of transferring multimedia content between devices according to an embodiment. At 501, multimedia content is streamed to a user's device. At 503, a request to change devices is received. As was noted above, such a request may be user-initiated or initiated automatically. For example, a user may dock a cellular phone, may connect a device to a second device to which the content should be transferred, may select a transfer option, etc. An automatic transfer may include a mechanism (such as GPS, proximity detection, detection of a home network, etc.) that detects that a user has arrived home or has moved out of range, for example.

At 505, if desired or required, the multimedia content is adjusted, reformatted or the like for the second device. At 507, a determination is made as to whether the multimedia content is to be routed to the second device by way of the first device. If not, at 509 the multimedia content is routed directly to the second device. If the multimedia content is to be transferred to the second device by way of the first device, then at 511 the multimedia content is send directly to the second device (possibly by way of an intermediate device such as a router, modem, cable box, etc.).

It should be appreciated that any or all of the features discussed herein may be implemented by a computing device that is executing computer instructions stored on a computer readable medium. Computer readable media may be any media that can be accessed by a computer. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by a computing device. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

While the various embodiments have been described in connection with the preferred embodiments of the various figures, it is to be understood that other similar embodiments may be used or modifications and additions may be made to the described embodiment for performing the same function of the various embodiments without deviating therefrom. Therefore, the embodiments should not be limited to any single embodiment, but rather should be construed in breadth and scope in accordance with the appended claims.

What is claimed:

1. A method comprising:
streaming multimedia content to a first device;
detecting a request to transfer the multimedia content from the first device to a second device;
determining whether the multimedia content is to be (i) streamed to the second device or (ii) streamed to the second device by way of the first device; and
streaming the multimedia content to the second device in accordance with the determination.

2. The method of claim 1, further comprising adjusting a characteristic of the multimedia content in accordance with a characteristic of the second device.

3. The method of claim 2, wherein the characteristic of the multimedia content is any one of: resolution, data rate and audio format.

4. The method of claim 2, wherein the characteristic of the second device is any one of: display size, display resolution and audio capability.

5. The method of claim 1, wherein the request is detected from the first or second device.

6. The method of claim 1, wherein the multimedia content is any one of: IP-based television, broadcast television, music, pictures and video images.

7. The method of claim 1, wherein the request is generated in response to any one of: a proximity determination, a location determination and user input.

8. The method of claim 7, wherein the user input comprises any one of: placement of the first device into a cradle and using the first or second device to generate the request.

9. The method of claim 1, wherein the multimedia content is streamed to the first device by way of a wireless network, and streamed to the second device by way of a wired network.

10. The method of claim 9, wherein the wireless network is a cellular or satellite network, and the wired network is any one of: a cable network, a DSL network and a POTS-based network.

11. The method of claim 1, wherein streaming the multimedia content to the second device by way of the first device comprises streaming the multimedia content to the first device and transmitting, using the first device, the multimedia content to the second device.

12. The method of claim 11, wherein said transmitting is by way of a wired or wireless connection.

13. The method of claim 1, wherein streaming the multimedia content to the second device comprises:
discontinuing streaming of the multimedia content to the first device; and
restarting streaming of the multimedia content to the second device.

14. The method of claim 13, wherein said discontinuing occurs at a first location within the streamed multimedia content and wherein said restarting of the multimedia content occurs substantially at the first location within the streamed media content.

15. The method of claim 13, wherein said discontinuing occurs at a first location within the streamed multimedia content and wherein said restarting of the multimedia content occurs at a second location within the streamed media content.

16. The method of claim 1, wherein the first device is any one of: a cellular telephone, a Personal Digital Assistant (PDA), a television and a computer.

17. The method of claim 1, wherein the second device is any one of: a cellular telephone, a Personal Digital Assistant (PDA), a television and a computer.

18. A system for transferring multimedia content from a first device to a second device, said system comprising at least one subsystem that:
streams multimedia content to a first device;
detects a request to transfer the multimedia content from the first device to a second device;
determines whether the multimedia content is to be (i) streamed to the second device or (ii) streamed to the second device by way of the first device; and
streams the multimedia content to the second device in accordance with the determination.

19. The system of claim 18, further comprising at least one subsystem that adjusts a characteristic of the multimedia content in accordance with a characteristic of the second device.

20. The system of claim 18, wherein the request is detected from the first or second device.

21. The system of claim 18, wherein the multimedia content is any one of: IP-based television, broadcast television, music, pictures and video images.

22. The system of claim 18, wherein the multimedia content is streamed to the first device by way of a wireless network, and streamed to the second device by way of a wired network.

23. The system of claim 18, wherein the at least one subsystem that streams the multimedia content to the second device further:
discontinues streaming of the multimedia content to the first device; and
restarts streaming of the multimedia content to the second device.

24. The system of claim 18, wherein the first device is any one of: a cellular telephone, a Personal Digital Assistant (PDA), a television and a computer.

25. The system of claim 18, wherein the second device is any one of: a cellular telephone, a Personal Digital Assistant (PDA), a television and a computer.

26. A computer-readable medium having computer-readable instructions, said computer-readable instructions comprising instructions for:
streaming multimedia content to a first device;
detecting a request to transfer the multimedia content from the first device to a second device;
determining whether the multimedia content is to be (i) streamed to the second device or (ii) streamed to the second device by way of the first device; and
streaming the multimedia content to the second device in accordance with the determination.

27. The computer-readable medium of claim 26, said computer-readable instructions comprising further instructions for adjusting a characteristic of the multimedia content in accordance with a characteristic of the second device.

28. The computer-readable medium of claim 26, wherein streaming the multimedia content to the second device comprises:
discontinuing streaming of the multimedia content to the first device; and
restarting streaming of the multimedia content to the second device.
